(19) United States
(12) Patent Application Publication
(10) Pub. No.: US 2026/0319586 A1
(43) Pub. Date: Oct. 15, 2026

(54) Haptic and Touch-Based Feedback System for Camera Control Panels in Live Broadcast Environments

(71) Applicant: Scott Timothy Rohrer, Dayton, OH (US)

(72) Inventor: Scott Timothy Rohrer, Dayton, OH (US)

(21) Appl. No.: 19/178,853

(22) Filed: Apr. 14, 2025

(51) Int. Cl. G06F 3/01; G06F 3/044; G06F 3/045; H04N 23/62; H04N 23/66

(52) U.S. Cl. CPC G06F 3/016; G06F 3/044; G06F 3/045; H04N 23/62; H04N 23/66

(57) ABSTRACT

A broadcast camera control system incorporating haptic feedback and optional touch sensing to notify an operator when a controlled camera is live (“tallied”). The system enhances operator awareness and helps prevent adjustments to live cameras by providing tactile alerts synchronized with tally status and physical operator interaction with the control panel.

### BACKGROUND OF THE INVENTION

In broadcast engineering, Camera Control Panels (“CCP”) are used to remotely manage settings of one or multiple cameras during live productions. Operators frequently adjust camera parameters such as iris, gain, and color balance. When a camera is “on air,” it is common practice to signal its status with a tally light visible on the camera and sometimes on the CCP. When a camera is “on air”, it is also common practice to minimize drastic adjustments to camera parameters. However, in fast-paced live environments, operators may overlook visual indicators and unintentionally adjust a live camera, disrupting the broadcast.

### SUMMARY OF THE INVENTION

This invention introduces a system that integrates a haptic feedback mechanism (e.g., vibration motor, linear actuator, or similar vibration-producing component) into the CCP to provide tactile notification when the associated camera is live. Optionally, a capacitive, proximity, or touch sensor may be included so that the haptic alert is triggered only when the operator is physically interacting with the CCP. This approach enhances operator situational awareness without requiring visual confirmation, reducing the risk of unwanted live camera adjustments.

### BRIEF DESCRIPTION OF DRAWINGS

FIG. 1 is a flowchart illustrating the operational logic of the haptic feedback system. It shows the decision-making process upon receiving a camera “on air” tally signal (101), processing the signal based on the presence of a touch sensor (102) and the operator's interaction with the panel (103), generation an activation signal (104), activation of the haptic module in response to tally signals (105), and looping logic (106) to repeat the process continuously.

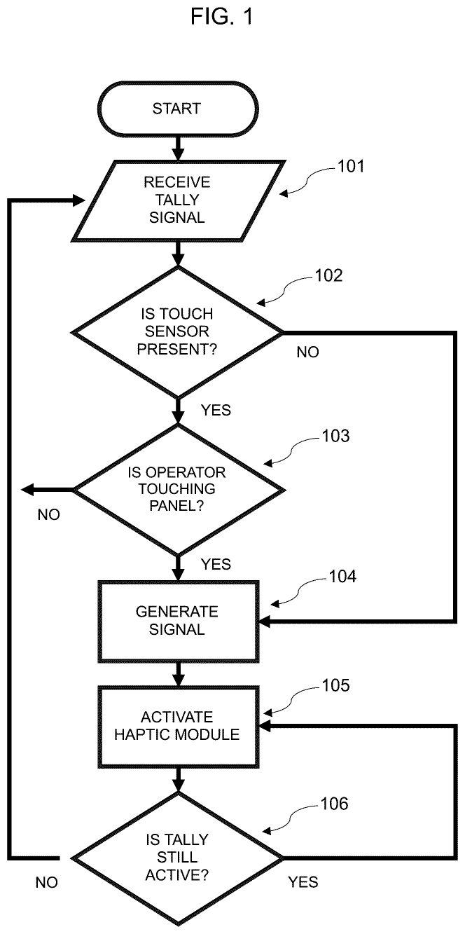

FIG. 2 is a block diagram of the broadcast control system components and the signals between them. A camera (201) may be connected to a camera control unit (“CCU”) (202). The camera's (201) video signal output (203) may be sent to the video signal switcher (204). The camera's control data (205), including “on air” tally information signals, may be conveyed between the CCU (202) and the CCP (206). “On air” tally signals may be conveyed between the video switcher (204) and the CCP (206) internal signal processor (207). The internal signal processor (207) may activate the internal haptic module (208) based on the status of the tally signal and optional internal touch sensor (209). A separate, optional, external embodiment (210) is shown in instances where the CCP (206) lacks the internal signal processor (207), internal haptic module (208), and/or internal touch sensor (209). In which case, an external signal processor (211) may be integrated with the video signal switcher (204), receive input from an touch sensor attached to the CCP (213), and activate a haptic module attached to the CCP (212). Any or all of the external devices (211, 212, 213) may be mounted to or inside the CCP (206) using an attachment mount (214).

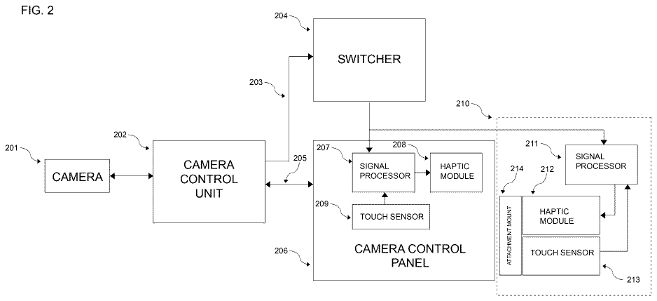

### DETAILED DESCRIPTION OF THE INVENTION

The invention consists of the following components:
a. A standard Camera Control Panel (“CCP”) or Remote Control Panel (“RCP”). (206)
b. A microcontroller or signal processor capable of receiving tally signals from a video router, switcher, or tally controller. (207)
c. A haptic feedback module (such as a vibration motor or piezo actuator). (208)
d. Optionally, a touch sensor integrated into the CCP control interface (e.g., knob, joystick, or surface panel). (209)

### Operational Logic:

a. When a tally signal is received for a camera currently selected or controlled on the CCP:
   i. If touch sensing is not used, the CCP vibrates immediately to indicate the live status. (102)
   ii. If touch sensing is used, the vibration is triggered only when both:
      1. The operator is touching the panel (as detected by the sensor) (103), and
      2. the Associated Camera Is On-air. (101)
b. The vibration may be generated by a signal that varies in intensity, duration, or pattern (104) based on:
   i. Type of tally (program, preview, iso, aux)
   ii. Length of tally state (e.g., constant vs. flash)
   iii. Operator customization, preference, or system settings

Add-On Version: In an alternate embodiment, the haptic feedback system is implemented as an after-market module designed to retrofit existing Camera Control Panels (CCPs) that do not natively support haptic feedback (210). This module may be a single device or a collection of multiple devices attached externally via adhesive, hook and loop tape, mounting brackets, or custom enclosures (214), and connected via:
a. Tally signal pass-through or splitter or processor, which taps into the existing tally feed.
b. Power via USB or external battery, or integrated with the CCP's power supply if accessible.
c. Optional data integration through serial, Ethernet, or GPIO ports on modern CCPs (when available), or standalone operation triggered purely by tally logic or a tally processor. Alternatively, the system may integrate with a photocell sensor affixed to an existing tally light—on a monitor, CCP, or camera—allowing the haptic module to be triggered based on detected light output rather than direct signal wiring.
d. The aftermarket device may also feature:
   i. Adjustable vibration profiles via dip switches, central controller user interface, Bluetooth app, or control knob.
   ii. Configurable touch sensing (e.g., by stick-on capacitive overlay on control knobs).
   iii. LED indicators for diagnostic or training purposes.
e. This version allows broadcasters to enhance older or more basic CCP hardware with haptic alerting functionality without replacing the entire system.

1. A camera control system comprising a haptic feedback mechanism integrated into a Camera Control Panel, configured to provide tactile feedback when a controlled camera is live (on-air, tallied).

2. The system of claim 1, wherein the haptic feedback is activated only when the operator is in contact with the control panel.

3. The system of claim 1, wherein the haptic feedback intensity or pattern is modifiable based on the type or duration of the tally signal.

4. The system of claim 1, wherein the control panel includes a capacitive or resistive touch sensor for detecting operator contact.

5. A retrofit device configured to attach to a Camera Control Panel and provide haptic feedback when a camera is tallied, the device comprising a tally input interface, a haptic actuator, and optionally a touch sensor, wherein the device operates independently of the native design of the control panel.
